(19) United States
(12) Patent Application Publication
(10) Pub. No.: US 2014/0223994 A1
(43) Pub. Date: Aug. 14, 2014

(54) Direct Sampling Device for Contamination-Free Transfer of Analyte

(71) Applicant: FLIR Systems, Inc., Wilsonville, OR (US)

(72) Inventors: Steven B. Shaull, Stillwater, OK (US); Aaron K. Thompson, Tulsa, OK (US); Amanda K. Aker, Stillwater, OK (US)

(21) Appl. No.: 14/345,907

(22) PCT Filed: Sep. 19, 2012
(86) PCT No.: PCT/US12/56073

§ 371 Date: Mar. 19, 2014

Related U.S. Application Data
(60) Provisional application No. 61/536,462, filed on Sep. 19, 2011.

(51) Int. Cl. G01N 1/00; H01J 49/04; G01N 30/02

(52) U.S. Cl. CPC G01N 1/00; G01N 30/02; H01J 49/0409; G01N 2001/002
USPC 73/23.41; 73/863; 73/864.81; 250/288

(57) ABSTRACT

A device and method for contamination-free transfer of samples is described. The device comprises an elongated member having an internal cavity and pressure-sensitive region. The internal cavity is in communication with at least a first open end of the elongated member. The pressure-sensitive region is disposed at a first distance from the first open end thereby forming a sampling portion of the device. The portion between the pressure-sensitive region and the second end forms a handling portion of the device. The pressure-sensitive region provides a stress concentration that increases the sensitivity to pressure. The device is used by contacting a sample with the first open end thereby causing sample to be received into the internal cavity of the sampling portion. The device is then inserted into a receiving container for use in the desired chemical analysis instrument. Pressure is applied to the pressure-sensitive region against the upper edge or wall of the receiving container thereby causing the sampling portion to be separated from the handling portion. The sampling portion and associated sample is retained in the receiving container which is then placed in the desired chemical analysis instrument for content determination without removal of the sampling portion. The handling portion can then be discarded. Thus, the sample is contained within the device at all times during sample collection and analysis which eliminates the possibility of contamination of the instrument and surrounding surfaces.

### BACKGROUND

Several chemical analysis instruments utilize a direct sample introduction (DSI) attachment for gas chromatography (GC) and mass spectrometry (MS). Standard DSI techniques for GC and MS instruments involve placing a sample material into a microvial which is subsequently positioned in a modified inlet. Due to their size, loading these microvials with solid samples, such as trace residue and powders, can be difficult without contaminating the instrument. The standard approach for transferring these types of samples to a microvial involves collecting the sample with a Pasteur pipette and subsequently shaking or tapping the sample into the microvial. Another transfer method involves folding a piece of paper, adding the sample to the paper, and then sliding the microvial through the sample. These approaches often result in contamination of neighboring surfaces including the DSI probe. Accordingly, a device and sampling method is needed to alleviate the contamination issues associated with these current transfer techniques.

### SUMMARY

A contamination-free sample transfer device and method is provided. The device comprises an elongated member having an internal cavity and a pressure-sensitive region. The internal cavity is in communication with a first end of the elongated member such that sample can be received into the internal cavity by contacting the sample with the first end. The internal cavity can extend through only a portion of the elongated member or alternatively, can extend to and communicate with a second end of the elongated member. The pressure sensitive region is positioned at a first distance from the first end such that the portion of the elongated member between the first end and pressure sensitive region forms the separable sampling portion. A handling portion is positioned between the second end of the elongated member and the pressure-sensitive region.

The elongated member can be formed of an inert material that does not out gas between 180 degrees Celsius and 300 degrees Celsius. In one instance, the elongated member is formed of glass. The elongated member is of a size sufficient to permit stable handling and placement of the sampling portion into a receiving container, such as a microvial for a DSI probe. For example, the elongated member has a length from about 65 millimeters (2.5 inches) to about 25.4 centimeters (10 inches), and more preferably about 10.2 centimeters (4 inches). The outer diameter of the elongated member should be of a size sufficient to permit insertion into a sample receiving container used with a standard chemical analysis instrument. For example, the outer diameter of the elongated member is from about 0.1mm (0.0004 inches) to about 1 5 millimeters (0.059 inches) and is preferably 1.18 millimeters (0.0465 inches). Alternatively, the elongated member can be completely solid with a quadrilateral cross-section such that the device may not include an internal cavity. In this instance, sample is retained on an edge or wall of the sampling portion of the device. Moreover, perforations can be used with solid devices to form a pressure-sensitive region.

The internal cavity is preferably of a diameter and length sufficient to receive the desired quantity of sample. In some instances, the diameter of the internal cavity will be dependent on the diameter of the elongated member. For example, an elongated member having a diameter of 1.18 millimeters preferably comprises an internal cavity with a diameter of about 0.546 millimeters (0.02151 inches). The internal cavity may be of a length that extends from the first end of the elongated member to immediately below the pressure-sensitive region. Alternatively, the internal cavity can extend from the first end to the second end of the elongated member such that both ends are in communication with the internal cavity. In instances where the elongated member is a hollow tube, the internal cavity is characterized by the hollow internal space of the elongated member such that the diameter of the internal cavity is the inner diameter of the elongated member.

The pressure-sensitive region provides a stress concentration on the elongated member such that this region is more susceptible to breaking than the remainder of the elongated member when a pressure or force is applied. For example, the pressure-sensitive region can be a scored or perforated segment on the elongated member. Alternatively, the pressure-sensitive region can be a partial cut in a wall of the elongated member. More generally, the pressure-sensitive region can comprise any means that provides a stress concentration on the device thereby causing an increased susceptibility to breaking as compared to the remainder of the elongated member when pressure or force is applied to the sampling portion of the elongated member. The means can include any of the aforementioned structural modifications listed above including a scored segment, a perforated segment, or a partial cut in the wall of the elongated member.

The pressure-sensitive region is positioned on the elongated member at a first distance from the first end of the elongated member. In one instance, the first distance provides the length of the separable sampling portion of the elongated member and should be sufficient to retain a desired amount of sample in the internal cavity of the sampling portion below the pressure-sensitive region. For example, the first distance is from about 5 millimeters to about 17 millimeters, and preferably is about 13 millimeters.

In another instance, the device may comprise multiple pressure-sensitive regions thereby creating multiple separable sampling portions. For example, the device may comprise a second pressure-sensitive region positioned at a second distance from the first end of the elongated member. The second distance may be from about 10 millimeters to about 34 millimeters and is preferably about 26 millimeters.

A method for contamination-free loading of a sample into a receiving container of a chemical analysis instrument using the present device is also provided. The method involves contacting the sample with a first end of a sampling device, the first end being in communication with an internal cavity of the sampling device such that a portion of the sample is received by the internal cavity, retained on an edge of the first end, or retained on a side wall of the device near the first end. A first portion of the sampling device containing the sample is then inserted into a receiving container where the first portion extends from the first end to a first pressure-sensitive region on the sampling device. Pressure is then applied to the sampling device against an internal wall of the receiving container thereby causing the first portion to separate from the sampling device at the first pressure-sensitive region such that the first portion containing the sample is retained in the receiving container. The portion of the sampling device above the pressure-sensitive region is then discarded and the sample is analyzed without removing the first portion from the receiving container.

This method can further include repeating these steps where the sampling device comprises a second pressure-sensitive region located in the device portion above the first pressure-sensitive region. This permits multiple samples to be obtained and transferred with a single device. Additionally, the steps can be repeated without performing the contacting step for a second time. In this instance, the step of contacting the sample resulted in the sample extending in the internal cavity to a point between the first pressure-sensitive region and the second pressure-sensitive region. This method will typically be employed where quantification of the level of analyte at varying depths of the sample are desired.

A method for contamination-free loading of a liquid sample into a receiving container of a chemical analysis instrument using the present device is also provided. The first step of the method involves applying a blockade to a first open end of a sampling device. Second, a second open end of the sampling device is placed into the liquid sample. In this method, the sampling device comprises an internal cavity that is in communication with the first and second open ends. Third, the blockade to the first open end is removed thereby causing a portion of the liquid sample to be received by the internal cavity via the second open end. Fourth, the blockade to the first open end is re-applied upon receipt of sufficient liquid sample into the internal cavity. Fifth, and while maintaining the blockade of the first open end, a portion of the sampling device is inserted into the receiving container. The inserted portion comprises a portion below a first pressure-sensitive region and contains the portion of liquid sample received by the internal cavity via the second open end. Sixth, pressure is applied to the first pressure-sensitive region against the receiving container in a manner sufficient to cause the sampling device to separate into two portions, the portion below the first pressure-sensitive region and a portion above the first pressure-sensitive region. In this instance, the portion below the first pressure-sensitive region is retained in the receiving container. Seventh and finally, the portion of liquid sample is analyzed without removing the portion of the sampling device below the first pressure-sensitive region from the receiving container.

### BRIEF DESCRIPTION OF FIGURES

FIG. 1 is a perspective view of one embodiment of the present device.

FIG. 2 is a perspective view of one embodiment of the present device comprising an internal cavity that terminates at the pressure-sensitive region.

FIG. 3A is a perspective view of one embodiment of the present device with multiple pressure-sensitive regions.

FIG. 3B is a perspective view of one embodiment of the present device with multiple pressure-sensitive regions comprising an internal cavity that terminates at the second pressure-sensitive region.

FIG. 4 is a perspective view of one embodiment of the present device with a pressure-sensitive region comprising a partial cut.

FIG. 5 is a perspective view of one embodiment of the present device with a pressure-sensitive region comprising a plurality of perforations.

FIG. 6 is a perspective view of one embodiment of the present device with a pressure-sensitive region comprising a single perforation.

FIG. 7A depicts the device of FIG. 1 contacting and collecting a sample.

FIG. 7B depicts inserting the device of FIG. 1 into a receiving container.

FIG. 7C depicts the sampling portion of the device of FIG. 1 separated from the remaining device and retained in the receiving container.

FIG. 8 is a gas chromatogram (upper panel) and mass spectrum (lower panel) of a sample of gastric content obtained using the present device and methods.

FIG. 9 is a gas chromatogram (upper panel) and mass spectrum (lower panel) of a sample of orange peel obtained using the present device and methods.

FIG. 10 is a gas chromatogram of a sample of an unknown plant sample obtained using the present device and methods.

FIG. 11 is a gas chromatogram (lower panel) and mass spectrum (upper panel) of a sample of an unknown powdery substance obtained using the present device and methods.

### DETAILED DESCRIPTION

The current invention is directed to a device and method for contamination-free transfer of material. For example, the device and method can be used in conjunction with a variety of DSI attachments for gas chromatography and/or mass spectrometry sample analysis and other chemical analysis requiring high temperature pyrolysis. More generally, the present device and method can be used for many laboratory and field applications where contamination-free transfer of small amounts of material is required. As used herein, the term “direct sample introduction attachment” is a device used with a GC and/or MS instrument that permits introduction of samples beyond gases and liquids that are not readily able to be introduced into said instrument without further processing.

The device comprises an elongated member having an internal cavity in communication with at least one end of the elongated member and a pressure-sensitive region. The internal cavity receives a portion of the target sample via an open end of the elongated member that is in communication with the internal cavity. Additionally, sample may be contained on the outer walls of the elongated member near the open end. The pressure-sensitive region allows the portion of the elongated member containing the sample (sampling portion) to be separated from the remaining device by applying pressure or force to the device against the receiving container. Thus, the sample is retained in the sampling portion throughout the transfer process and subsequent analysis thereby reducing or eliminating contamination of the assay equipment and surrounding areas or surfaces.

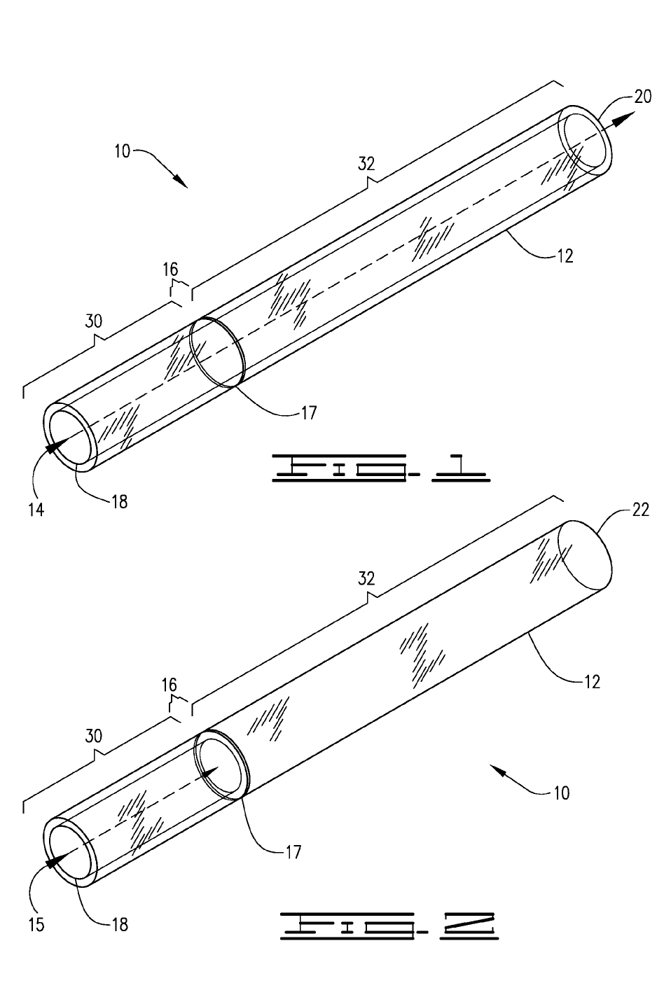

One embodiment of the device 10 is depicted in FIG. 1. The device 10 comprises an elongated member 12 with an internal cavity 14 and a pressure-sensitive region 16. In this instance, the pressure-sensitive region 16 comprises a score 17 which extends around the perimeter of the elongated member 12. Elongated member 12 has a first open end 18 and a second open end 20, both of which are in communication with internal cavity 14. Sampling portion 30 includes the portion of elongated member 12 between the first open end 18 and pressure-sensitive region 16. Handling portion 32 includes the portion of elongated member 12 between pressure-sensitive region 16 and second open end 20.

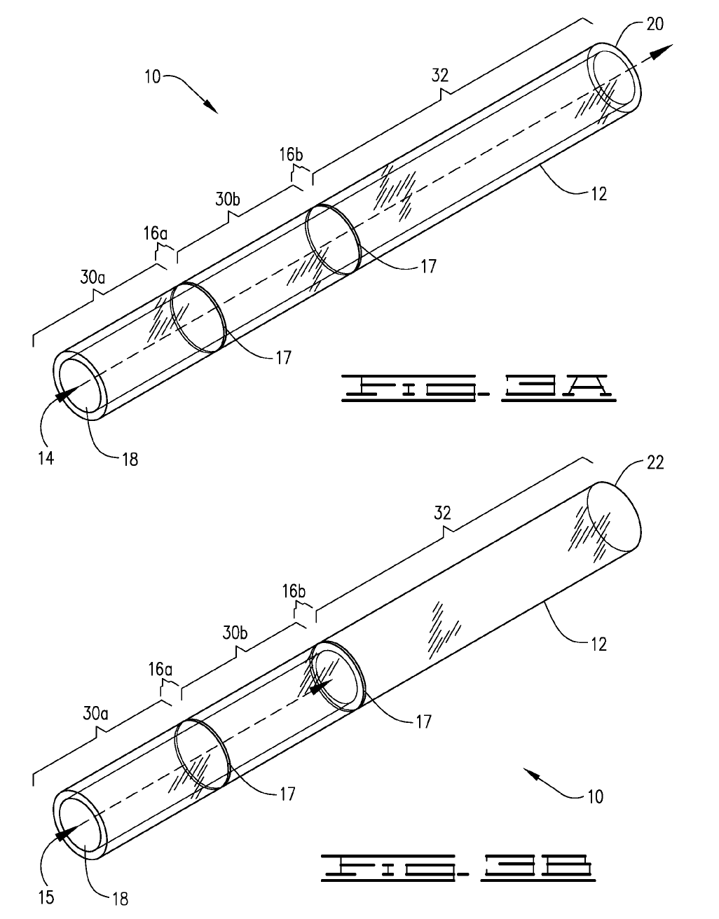

Referring now to FIG. 2, device 10 comprises an internal cavity 15 that extends to the pressure-sensitive region 16 such that elongated member 12 has a second end 22 that is solid and is not in communication with internal cavity 15. This embodiment is primarily used for solid samples in which a capillary action is not required and provides increased strength and durability to handling portion 32. It should be understood that internal cavity 15 can terminate just below pressure-sensitive region 16 or extend slightly beyond pressure-sensitive region 16. This may depend on the type of material and the type of pressure-sensitive region 16 used in a particular device. For example, in instance in which internal cavity 15 terminates below a pressure-sensitive region 16 comprising a score 17, the score depth and width may need to be increased to provide the same pressure-sensitivity as a device such as depicted in FIG. 1.

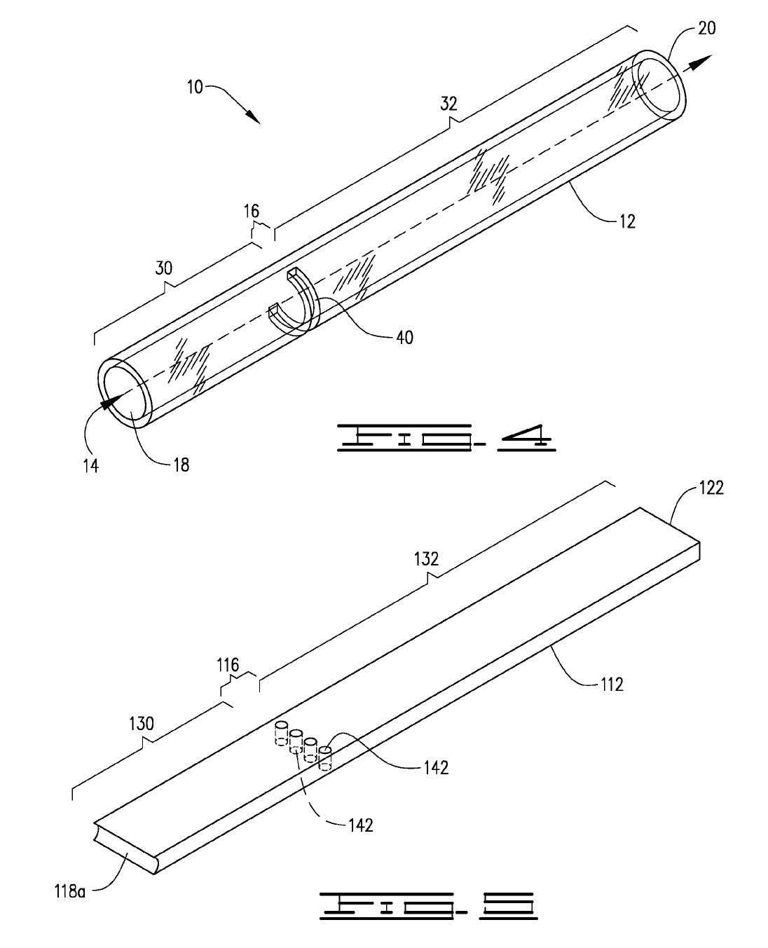

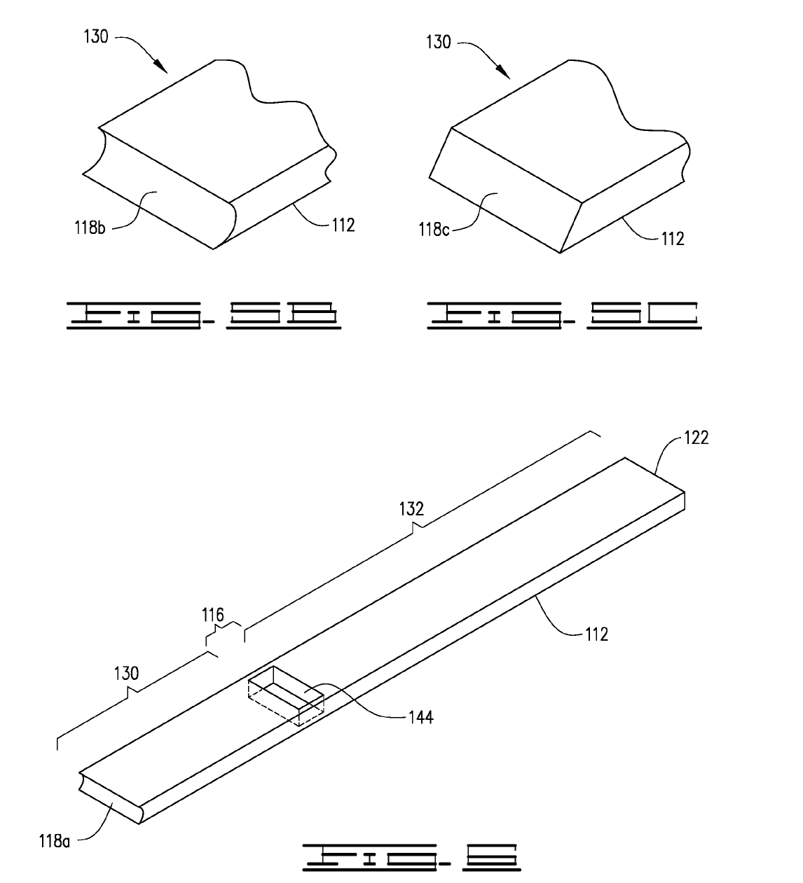

FIGS. 3A and 3B depict device 10 comprising two pressure-sensitive regions 16a, 16b thereby providing two sampling portions 30a, 30b. However, it should be understood that device 10 can comprise any number of pressure-sensitive regions 16, such as from about 3 to about 8 pressure-sensitive regions. In instances where more than two pressure-sensitive regions are desired, the overall length of the device may have to be increased in order to provide a sufficient handling portion 32. As described above, internal cavity 14 can extend from first open end 18 to second open end 20 as depicted in FIG. 3A. Alternatively, internal cavity 15 can terminate at the pressure-sensitive region 16b as depicted in FIG. 3B or immediately after pressure-sensitive region 16b thereby rendering a generally solid handling portion 32. In either instance, device 10 can be inserted through a solid or semi-solid sample material (sponge, gel, etc.) filling one or more sampling portions 30a and 30b thereby allowing for a quantitative analysis of the concentration of a target analyte at different levels in the sampled material. Moreover, multiple sampling portions permit transfer of multiple samples with a single device which reduces waste and provides a more efficient use of resources. The pressure sensitive regions 16a and 16b are formed by a score 17 as depicted in FIGS. 3A and 3B. However, it should be appreciated that pressure-sensitive regions 16a and 16b can be formed using the approaches depicted in FIGS. 4-6 and described in detail below or any combination thereof. Each sampling portion 30a, 30b can be selectively separated by targeting pressure or force directly to the desired pressure-sensitive region 16a or 16b against the top edge of the receiving container in which the sampling portion is to be deposited.

FIGS. 4-6 depict alternative approaches to providing a pressure-sensitive region 16. In FIG. 4, device 10 is depicted with a pressure-sensitive region 16 comprising a void or cut section 40. This approach is useful when the device is formed of materials having a lower modulus of elasticity which tend to break only after the material has elongated or stretched. Examples of such materials include aluminum, copper, certain steels and metal alloys, and softer plastics. Thus, with these materials, scoring will not result in the desired clean break at the pressure-sensitive region 16. By applying pressure towards the cut 40 of the device, compression forces in the uncut portion will be eliminated thereby permitting a clean break. In some instances, the cut section 40 may have a depth of more than 50% of the device's diameter. However, the depth of the cut will depend on the modulus of elasticity of the device material and could be from about 50% to about 90% or any intermediate percentage between. Furthermore, internal cavity 14 may extend through the device as depicted in FIG. 4 which will often intersect cut region 40. Alternatively, the internal cavity may be confined to the sampling portion 30 as shown in FIG. 2 or device 10 may be solid with no internal cavity. Cut 40 can be created using most standard or diamond blade saws, water jets, or lasers.

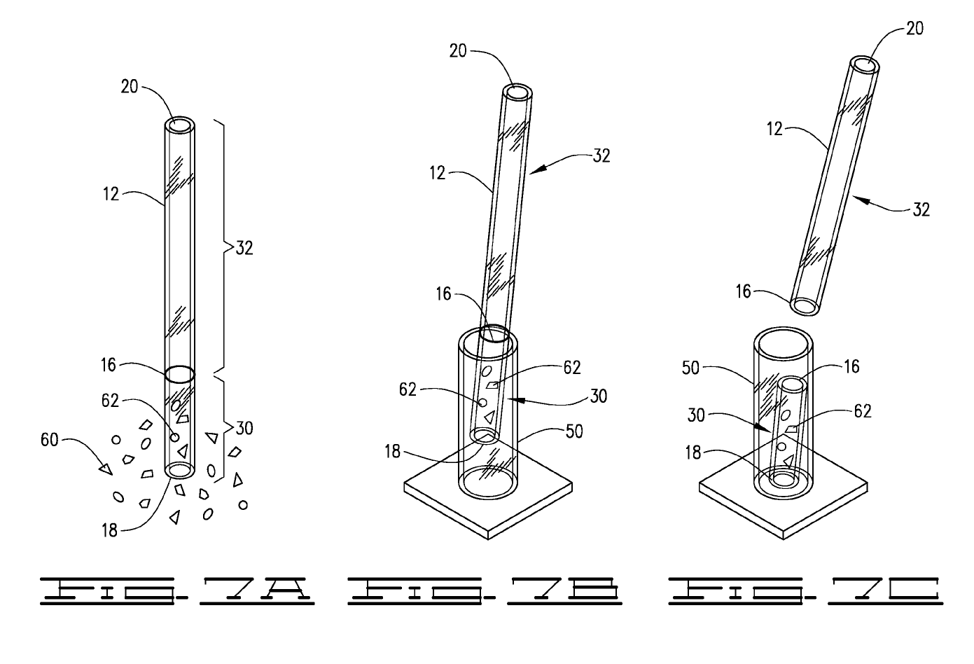

Referring now to FIG. 5, elongated member 112 is solid (no internal cavity) with a rectangular cross-section having a first end 118a and second end 122. Here, pressure-sensitive region 116 comprises a series of perforations 142 which extend through elongated member 112. Furthermore, first end 118a comprises a means for obtaining a portion of a sample. As depicted in FIGS. 5 and 5B, the means for obtaining a portion of sample includes first end 118a, 118b having a concave shape. Referring now to FIG. 5C, the means for obtaining a portion of sample can also include first end 118c having an angled surface. FIG. 6 depicts the device comprising a single, larger perforation 144 for its pressure-sensitive region 116. It should be understood that the device in FIG. 6 can include any of the first ends 118a, 118b, 118c having means for obtaining a portion of sample as depicting in FIGS. 5, 5B, and 5C. Moreover, the number of perforations 142 or size of perforation 144 is dependent on the type of material used and should be of sufficient number or size to produce a clean break when sufficient pressure is applied against the receiving container.

In any of the above described embodiments, device 10 may be formed of glass or any inert material that does not out gas between 180° and 300° C. Examples of appropriate material include, but are not limited to ceramics, plastics such as polytetrafluoroethylene (Teflon), PAI, PEEK, PEAK, polyetherimide (Ultem), and metals such as aluminum, copper, stainless steel, nickel, steel, titanium, brass, and alloys thereof. The shape of device 10 is preferably an elongated, cylindrical member with a circular cross-section. However, device 10 can have a variety of cross-sectional shapes including, but not limited to oval, figure eight, dumbbell shape, and any polygon convex or concave such as quadrilaterals, pentagons, heptagons, octagon, nonagon and decagon. Regardless, the shape and size of device 10 should permit efficient handling and include a sampling portion 30 that allows for a sufficient quantity of sample to be received or retained on a surface thereof while of a size to fit within the appropriate receiving container.

In one instance, device 10 comprises an elongated member 12 formed of a 4-inch (101.6 millimeters) glass capillary tube having an outside diameter (OD) of 1.18 millimeters (0.0465 inches) and an inner diameter (ID) of 0.546 millimeters (0.02151 inches), such as depicted in FIG. 1. In this instance, inner cavity 14 is defined by the ID or inner hollow portion of the glass capillary tube. Pressure-sensitive region 16 is positioned 13 millimeters (0.51 inches) from first end 18 and is formed by scoring the glass capillary tube.

The OD of elongated member 12 can be selected to conform to the size of the ID of the receiving container being used to receive sampling portion 30. Generally, the OD of elongated member 12 is from about 0.1 mm (0.0004 inches) to about 1.5 mm (0.059 inches) and is preferably 1.18 mm (0.0465 inches). The ID of elongated member 12 depends generally on the OD, the desired strength of member 12, the materials used to form member 12, and the desired capacity of inner cavity 14 in sampling portion 30. When a glass capillary tube is used as the elongated member 12 as discussed above, the ID is from about 1% to about 95% of the OD of the tube and preferably about 46% of the OD. Alternatively, a solid rod having a zero percent ID/OD ratio could be used in sampling substances that would adhere to the outside or edges of the rod such as gels, slurries, powders, or liquids. In other words, device 10 does not necessarily require internal cavity 14, 15 since, for some applications, the sample can adhere to the edge of an end of the sampling portion 30 or a surface thereof. The length of device 10 is generally related to the desired size of sampling portion 30 and handling portion 32 and is from about 26 mm (1 inch) to about 25.4 cm (10 inches), and more preferably from about 65 millimeters (2.5 inches) to about 130 millimeters (5⅛ inches). Sampling portion 30 (portion of elongated member 12 between pressure-sensitive region 16 and first end 18) should be of length that will permit it to be completely retained in the receiving container and furthermore, allows for receipt of a suitable quantity of sample. In one instance, sampling portion 30 is about 5 millimeters (0.197 inches) to about 17 millimeters (0.669 inches) and is preferably 13 millimeters (0.51 inches). These dimensions are applicable to a device 10 having one sampling portion 30 or multiple sampling portions 30a and 30b as in FIGS. 3A and 3B. Specifically, each sampling portion 30a and 30b can have a length of about 5 millimeters (0.197 inches) to about 17 millimeters (0.669inches) and are preferably 13 millimeters (0.51 inches).

Pressure-sensitive region 16 forms a stress concentration thereby causing an increased sensitivity to pressure or force in this region of elongated member 12. In one instance, as depicted in FIGS. 1, 2, 3A and 3B, pressure-sensitive region 16 comprises one or more scores 17 that extend around the perimeter of elongated member 12. Where elongated member 12 is a glass capillary tube having an outside diameter (OD) of 1.18 millimeters (0.0465 inches) and an inner diameter (ID) of 0.546 millimeters (0.02151 inches), score 17 has a depth of approximately 75 micrometers and a width of approximately 86 micrometers. A score of this magnitude creates a ratio of torque as compared to the unscored region of elongated member 12 of 3.2:1 (unscored: scored). The ratio of torque used should provide sufficient strength to avoid separation or breakage upon sampling of solid materials while allowing sampling portion 30 to be removed or separated from the remaining device without applying overly excessive pressure. However, the score depth and width may be greater or less depending on the material used for the device and the OD and ID of elongated member 12. The device 10 can be scored by a laser or automated scoring instrument such as that used by commercially available glass consumables services. Additionally, the score can be created using a triangular file, glass tubing cutter or scoring knife commercially available from most laboratory supply providers.

As discussed specifically above with respect to FIGS. 4-6, pressure-sensitive region 16 can comprise a cut 40, multiple perforations 42, 142 or a single perforation 44, 144 of varying size or shape. The use of perforations as the pressure-sensitive region will be more common in devices wherein the elongated member does not contain an internal cavity and/or the device has a non-circular cross-section such as a rectangular or square cross-section such as that depicted in FIGS. 5 and 6. In these instances, the perforations or single perforation extends through the elongated member at its thinnest point thereby creating the pressure-sensitive region.

Device 10 can be used in methods for contamination-free transfer of sample to a receiving container for use in a variety of chemical analysis instruments. For example, the receiving container can include a microvial (standard size—15 mm×2.5 mm OD×1.9 mm ID) for a DSI used with a GC/MS instrument, a TD tube for pyrolysis, or a graphite tube used in atomic absorption. Samples can include both underivatized or raw materials as well as those that have been chemically modified to facilitate their separation via chromatography.

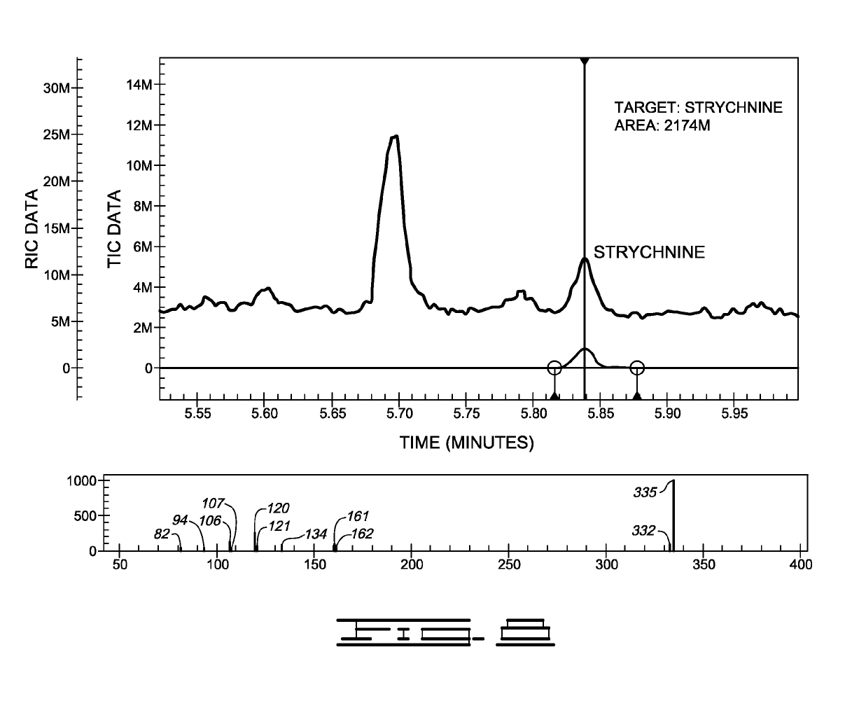

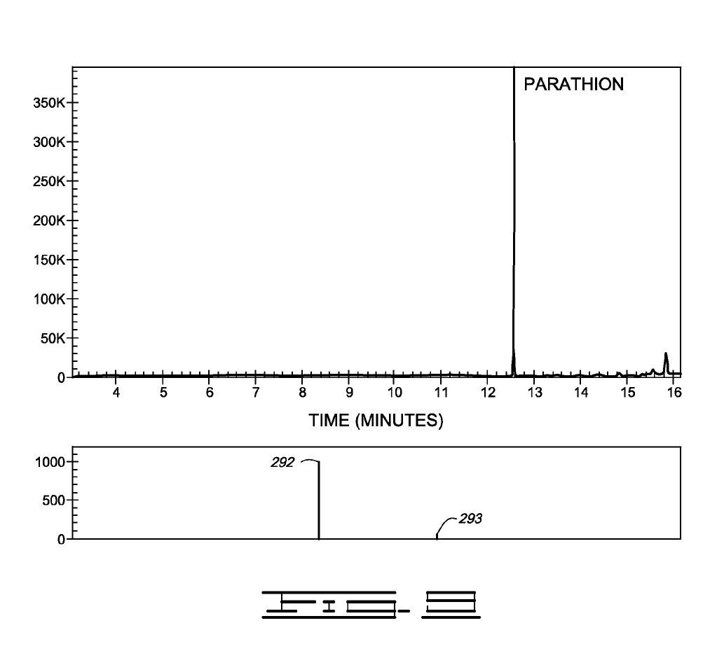

Referring now to FIG. 7A, the method generally comprises the first step of contacting sampling portion 30 of device 10 with a sample 60. A portion of sample 62 may be received by the inner cavity 14 of sampling portion 30 as depicted or may attach to the end or outer wall of the sampling portion 30. This type of sampling results in less quantitative results and is more for identification of the material within the sample.

Referring now to FIG. 7B, the second step comprises inserting sampling portion 30 of device 10 into a receiving container 50 and then applying pressure to or just below pressure-sensitive region 16 against the upper edge or side of the receiving container 50 thereby separating sampling portion 30 from handling portion 32. As depicted in FIG. 7C, sampling portion 30 and associated sample 62 remains in the receiving container 50. The receiving container 50 containing sampling portion 30 and sample 62 is subsequently transferred to the desired instrument for analysis and disposed of thereafter. Since sampling portion 30 remains in the receiving container 50, it is thermally desorbed itself, thus creating a precise transfer technique that avoids contamination of neighboring surfaces and of the instrument itself.

In methods using a device with multiple pressure-sensitive regions 16 (multiple sampling portions 30), for example device 10 of FIGS. 3A and 3B, the steps set forth in describing FIGS. 7A-C are repeated one or more times, depending on the number of pressure-sensitive regions 16 the device possesses. However, in the instance quantitative analysis of a sample having potentially differing levels of analyte at various sample depths, device 10 is inserted into the sample at a depth sufficient to fill the internal cavities 14 of two or more sampling portions 30. Each sampling portion 30 is then sequentially separated by applying pressure or force to each associated pressure-sensitive region 16 thereby depositing one sampling portion 30 in each of several receiving containers. It should be noted that a blockade may need to be applied to the second open end 20 during separation of all sampling portions from the device to aid in retention of the sample in the internal cavity. The sample contained in each sampling portion 30 can then be separately analyzed to determine the relative quantity of analyte at different levels in a sample.

Device 10 can also be used for contamination-free transfer of liquids. For example, in the identification of raw starting materials for methamphetamine production, law enforcement personnel will interact with and seize potentially dangerous liquid agents. By utilizing device 10, small liquid volumes may be collected and quickly analyzed with onsite instrumentation providing rapid identification of potentially illegal or dangerous substances. A device 10 comprising an elongated member 12 having an OD of 1.18 millimeters (0.0465 inches), an internal cavity 14 diameter of 0.546 millimeters (0.02151 inches), and a sampling portion 30 length of 13 millimeters possesses 3 microliters of total internal volume, which is a suitable volume for split-based GC/MS and other common industry analysis instruments.

A method of liquid-based sampling using device 10 of FIG. 1 is provided. The method comprises blocking second end 20 (by placing a finger over second end or some other blocking structure) and placing sampling portion 30 in the desired liquid sample. Upon release of the second end 20 blockade, the liquid is drawn into internal cavity 14. The sample may fill the internal cavity 14 beyond the pressure-sensitive region 16 or alternatively, the user can block second end 20 to stop liquid before it reaches the pressure-sensitive region 16. Regardless, before removing device 10 from the liquid sample, the user blocks second end 20 which prevents the sample from prematurely evacuating device 10. The user then inserts sampling portion 30 into the receiving container and applies pressure or force to pressure-sensitive region 16, or immediately below this region, against the receiving container while maintaining blockade of second end 20 thereby causing separation of sampling portion 30 and handling portion 32. Sampling portion 30 and liquid sample is retained in the receiving container and transferred to the desired instrument for chemical analysis of the liquid and handling portion 32 is discarded.

The inventive device can be used with a variety of solid materials. For example, fruits and vegetables may be subject to excessive pesticide exposure, with potentially fatal consequences. The present device 10 presents a unique approach to the analysis of pesticides and other environmentally persistent pollutants that may be introduced into the food chain. The technique for analysis of surface level contaminants involves sampling the outer surface of the fruit/vegetable with the present device 10 by dragging or pushing first open end 18 across the surface of the prospective food item. This will result in either rind being received into internal cavity 14 of sampling portion 30, or residue collecting to the edges of first opening 18. Additionally, sampling portion 30 may be physically inserted into the outer epidermis of the fruit/vegetable and removed likewise, collecting the outer skin of the material into internal cavity 14 of sampling portion 30. Sampling portion 30 is then separated from the remaining device 10 as described above.

The present device 10 may also be used with biological and synthetic plant materials including alkaloids, terpenoids, cannabinoids and other potentially psychoactive agents. Naturally occurring plants such as Salvia Divinorum contain low concentrations of psychoactive agents such as Salvinorin A. New generation “herbal incense” or synthetic cannabis contains residues of synthetic cannabinoids which have been sprayed onto plant material to produce a legal high. Due to the difficulties and labor associated with extraction of psychoactive chemicals within these plant materials—including low concentration components and unknown solubilities of the chemicals of interest—the present device 10 offers an excellent alternative for collection of the plant material for subsequent GC and/or MS analysis.

In methods involving use of device 10 with plant material, a user first isolates a section of plant material, either whole or cut into pieces for ease of handling, and repeatedly contacts the plant material with first end 18 of sampling portion 30 until visual residue is present on either the first end 18 and/or inner cavity 14 of sampling portion 30. The remaining steps are the same as set forth above. Use of the present device 10 in this method reduces sample preparation time from potentially hours (1-4) to an average of 1 minute.

In methods involving device 10 without an internal cavity 14, 15, such as that depicted in FIGS. 5 and 6, the sample will be retained on the outer surfaces of sampling portion 30 or on the edges of first end 18 through electrostatic interaction with the material of device 10. Otherwise, the methods involving such devices will be the same as that discussed above.

### EXAMPLES

In the Examples below, a device similar to that described in reference to FIG. 1 was used. Specifically, the device comprised a 4-inch glass capillary tube having an OD of 1.18 millimeters (0.0465 inches) and an ID of 0.546 millimeters (0.02151 inches) where the ID defined the diameter of the inner cavity and the inner cavity extended from the first end to the second end. The pressure-sensitive region comprised a score positioned 13 millimeters from the first open end with a scoring depth and width of 75 micrometers and 86 micrometers, respectively.

### Example 1

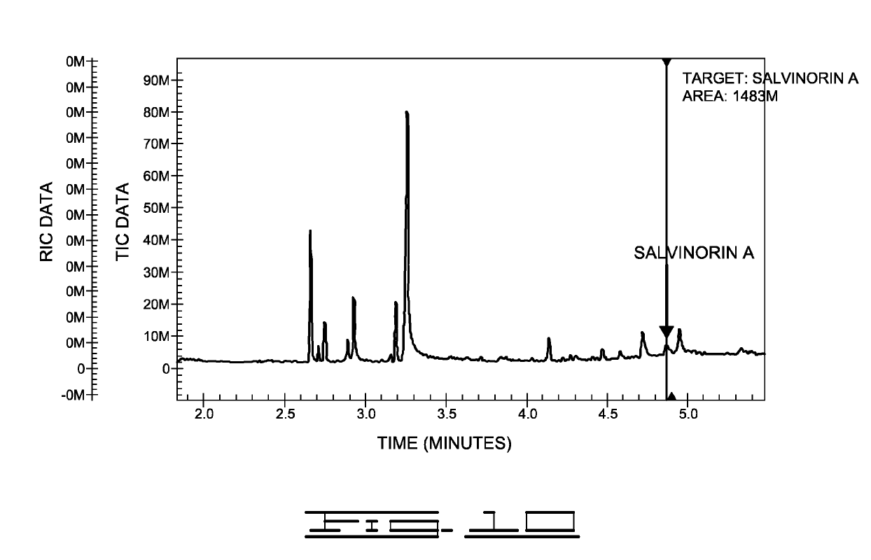

A sample of canine gastric contents from an animal previously suffering from seizures with subsequent vomiting was obtained and transferred to a microvial using the device and methods described herein. The microvial was then transferred to a DSI probe and inserted into the GC/MS analysis instrument. The results of the GC (top panel)/MS (bottom panel) analysis of the gastric content sampled using the present device and methods are depicted in FIG. 8 and confirmed the presence of strychnine alkaloid. The sample preparation time was approximately one minute.

### Example 2

An orange peel sample was analyzed for surface level contaminants using GC/MS. The sample was obtained and transferred to a microvial for a DSI probe using the methods described herein for sampling fruits and vegetables. The results of the GC (top panel)/MS (bottom panel) analysis of the orange peel sample obtained using the present device and methods are depicted in FIG. 9 and confirmed the presence of parathion, a common pesticide. The sample preparation time was approximately one minute.

### Example 3

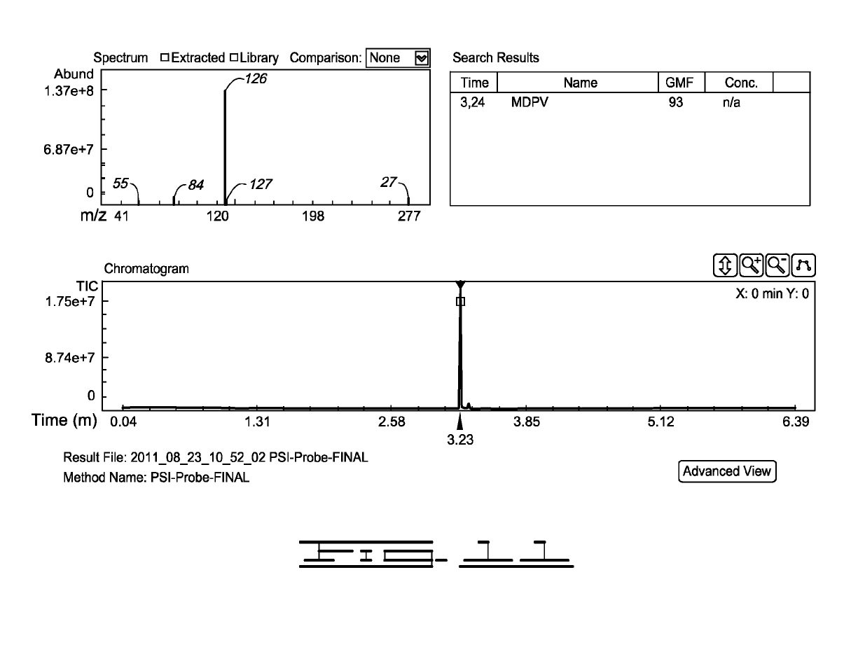

A plant material was sampled and transferred to a microvial for a DSI probe using the inventive device according to the methods described above for sampling plant material. The plant sample was subjected to GC analysis and the results depicted in FIG. 10 indicate the presence of Salvinorin A, a scheduled substance present within Salvia Divinorum. The sample preparation time was approximately one minute.

### Example 4

A powdery substance was sampled and transferred to a microvial for a DSI probe using the inventive device according to the general method described above. The powdery was subjected to GC analysis and the results depicted in FIG. 11 indicate the presence of 3,4-Methylenedioxypyrovalerone (MDPV), otherwise referred to as “bath salts.” The sample preparation time was approximately one minute.

Other embodiments of the presently described device and methods will be apparent to those skilled in the art from a consideration of this specification, including the examples, or practice of the invention disclosed herein. However, the foregoing specification is considered merely exemplary of the present invention with the true scope and spirit of the invention being indicated by the following claims.

1. A device for transferring substances to a sample container, the device comprising:
an elongated member comprising an internal cavity and a pressure-sensitive region, wherein the internal cavity is in communication with a first end of the elongated member, and wherein the pressure sensitive region is positioned at a first distance from the first end.

2. The device of claim 1, wherein the internal cavity is in communication with a second end of the elongated member.

3. The device of claim 1, wherein the pressure-sensitive region comprises a score extending around a perimeter of the elongated member.

4. The device of claim 3, wherein the score has a depth of about 75 micrometers and a width of about 86 micrometers.

5. The device of claim 1, wherein the pressure-sensitive region comprises one or more perforations.

6. The device of claim 1, wherein the pressure-sensitive region comprises a partial cut in the elongated member.

7. The device of claim 1, wherein the elongated member is formed of an inert material that does not out gas between 180 degrees Celsius and 300 degrees Celsius.

8. The device of claim 1, wherein the elongated member is formed of glass.

9. The device of claim 1, wherein the elongated member has an outside diameter of about 1.18 millimeters.

10. The device of claim 1, wherein the first distance is from about 5 millimeters to about 17 millimeters,

11. The device of claim 1, wherein the first distance is 13 millimeters.

12. The device of claim 1, further comprising a second pressure-sensitive region, wherein the second pressure-sensitive region is positioned at a second distance from the first end.

13. The device of claim 12, wherein the second distance is from about 10 millimeters to about 34 millimeters.

14. The device of claim 12, wherein the second distance is 26 millimeters.

15. The device of claim 1, wherein the elongated member has a total length of about 65 millimeters to about 260 millimeters.

16. The device of claim 1, wherein the elongated member has a total length of about 100 millimeters.

17. A method for loading of a sample into a receiving container of a chemical analysis instrument comprising the steps of:
contacting the sample with a first end of a sampling device, the first end being in communication with an internal cavity of the sampling device such that a portion of the sample is received by the internal cavity or retained on the first end;
inserting a first portion of the sampling device into the receiving container, wherein the first portion extends from the first end to a first pressure-sensitive region on the sampling device such that the first portion includes the portion of the sample received by the internal cavity or retained on the first end;
applying pressure to the sampling device against the receiving container in a manner sufficient to cause the first portion to separate from the sampling device at the first pressure-sensitive region, wherein the first portion is retained in the receiving container with the portion of the sample contained therein;
discarding the remainder of the device; and
analyzing the portion of the sample without removing the first portion from the receiving container.

18. The method of claim 17 wherein the sample is an item of food.

19. The method of claim 17 wherein the sample is a plant.

20. The method of claim 17, wherein the receiving container is a microvial used in connection with a direct sample introduction attachment for a gas chromotagraphy or mass spectrometry analysis instrument.

21. A method for loading of a sample into a receiving container of a chemical analysis instrument comprising the steps of:
contacting the sample with an open end of a sampling device, the open end being in communication with an internal cavity of the sampling device such that a portion of the sample is received by the internal cavity or retained on an edge of the open end;
inserting a portion of the sampling device into the receiving container, wherein the portion is below a first pressure-sensitive region and contains the portion of the sample received by the internal cavity or retained on an edge of the open end;
applying pressure to the sampling device against the receiving container in a manner sufficient to cause the sampling device to separate into two portions, the portion below the first pressure-sensitive region and a portion above the first pressure-sensitive region, wherein the portion below the first pressure-sensitive region is retained in the receiving container; and
analyzing the portion of the sample without removing the portion below the first pressure-sensitive region from the receiving container.

22. The method of claim 21, wherein the sampling device further comprises a second pressure-sensitive region contained in the portion above the first pressure-sensitive region, and wherein the method further comprises:
inserting a portion of the sampling device into the receiving container, wherein the portion is below a second pressure-sensitive region and contains the portion of the sample received by the internal cavity or retained on an edge of the open end;
applying pressure to the sampling device against the receiving container in a manner sufficient to cause the sampling device to separate into two portions, the portion below the second pressure-sensitive region and a portion above the second pressure-sensitive region, wherein the portion below the second pressure-sensitive region is retained in the receiving container; and
analyzing the portion of the sample without removing the portion below the second pressure-sensitive region from the receiving container.

23. The method of claim 22, wherein the sampling device further comprises a second pressure-sensitive region contained in the portion above the first pressure-sensitive region resulted in the portion of the sample received by the internal cavity to extend to a point between the first pressure-sensitive region and the second pressure-sensitive region.

24. The method of claim 21, wherein the sample is an item of food.

25. The method of claim 21, wherein the sample is a plant.

26. The method of claim 21, wherein the receiving container is a micro vial used in connection with a direct sample introduction attachment for a gas chromotagraphy or mass spectrometry analysis instrument.

27. A method for loading of a liquid sample into a receiving container of a chemical analysis instrument comprising the steps of:
applying a blockade to a first open end of a sampling device;
placing a second open end of the sampling device into the liquid sample, the first open end and second open end being in communication with an internal cavity of the sampling device;
removing the blockade to the first open end thereby causing a portion of the liquid sample to be received by the internal cavity via the second open end;
reapplying the blockade to the first open end upon receipt of sufficient liquid sample into the internal cavity;
inserting a portion of the sampling device into the receiving container, wherein the inserted portion is a portion below a first pressure-sensitive region and contains the portion of liquid sample received by the internal cavity via the second open end;
applying pressure to the first pressure-sensitive region of the sampling device against the receiving container in a manner sufficient to cause the sampling device to separate into two portions, the portion below the first pressure-sensitive region and a portion above the first pressure-sensitive region, wherein the portion below the first pressure-sensitive region is retained in the receiving container; and
analyzing the portion of liquid sample without removing the portion below the first pressure-sensitive region from the receiving container.

28. The method of claim 27 wherein the receiving container is a microvial used in connection with a direct sample introduction attachment for a gas chromotagraphy or mass spectrometry analysis instrument.

29. A device for transferring substances to a sample container, the device comprising:
an elongated member comprising a pressure-sensitive region, wherein the pressure sensitive region is positioned at a first distance from a first end.

30. The device of claim 29, wherein the pressure-sensitive region comprises a single perforation.

31. The device of claim 29, wherein the pressure-sensitive region comprises multiple perforations.

32. The device of claim 29, wherein the pressure-sensitive region comprises a partial cut in the elongated member.

33. The device of claim 29, wherein the elongated member is formed of an inert material that does not out gas between 180 degrees Celsius and 300 degrees Celsius.

34. The device of claim 29, wherein the elongated member is formed of a material from the group consisting of plastic, aluminum, copper, and metal alloys.

35. The device of claim 29, wherein the first distance is from about 5 millimeters to about 17 millimeters.

36. The device of claim 29, wherein the first distance is 13 millimeters.

37. The device of claim 29, further comprising a second pressure-sensitive region, wherein the second pressure-sensitive region is positioned at a second distance from the first end.

38. The device of claim 37, wherein the second distance is from about 10 millimeters to about 34 millimeters.

39. The device of claim 37, wherein the second distance is 26 millimeters.

40. The device of claim 29, wherein the elongated member has a total length of about 65 millimeters to about 260 millimeters.

41. The device of claim 29, wherein the elongated member has a total length of about 100 millimeters.

42. The device of claim 29, wherein the first end comprises a means to obtain a portion of a sample.

43. The device of claim 42, wherein said means to obtain a portion of a sample comprises the first end having a concave shape.

44. The device of claim 42, wherein said means to obtain a portion of a sample comprises the first end having an angled surface.
